(19) United States
(12) Patent Application Publication
(10) Pub. No.: US 2005/0046172 A1
(43) Pub. Date: Mar. 3, 2005

(54) Presentation folders

(76) Inventor: Adam Pacifico, London (GB)

Correspondence Address: BREINER & BREINER, L.L.C., P.O. Box 19290, Alexandria, VA, 22320-0290, US

(21) Appl. No.: 10/930,825

(22) Filed: Sep. 1, 2004

(30) Foreign Application Priority Data
Sep. 1, 2003 (GB) 0320456.7

(51) Int. Cl. B42D 1/00

(52) U.S. Cl. 281/15.1

(57) ABSTRACT

An improved presentation folder (1, 2) described for use, e.g., in a restaurant. The bill (15) is placed inside the folder and the folder and bill carried to the intended payer. When there is more than one payer, individual charge or credit cards and/or cash may be inserted into several pockets (10, 18), and by writing on remarkable sections (12), associated with each pocket, the payers can indicate to the service establishment e.g. how much of the bill is being paid by way of credit or charge card and how much in cash. The folder may include a calculator (20) to assist the payers with splitting the bill.

### FIELD OF THE INVENTION

This invention relates to presentation folders, and, in particular, to such folders as are conventionally used in restaurants and other service establishments to present the bill at the end of a meal or other activity.

### BACKGROUND TO THE INVENTION

For many years, it has been an established custom in a variety of service establishments such as restaurants and bars to present the bill for services to a customer in some form of folder. This has a number of advantages, first that the amount of the bill cannot be discerned when the folder is handed over, and secondly that it is easier to handle a folder than a loose relatively small piece of paper, such as, for example, a section of a paper roll which has been printed out by a machine itemising the items of food and drink and totaling the individual amounts.

A further advantage of presenting the bill in a folder is that very often the bill is settled either by credit card or by paper money, either of which may be simply placed in the folder which is then handed back to the service establishment staff whereon they can, in the case of paper money, produce the change and in the case of a credit or charge card, return this to the payer with the transaction authorisation slip likewise in the folder for signature, or for processing the transaction via the “Chip & PIN” procedure.

Numerous designs of folders have been produced, some personalised for the particular service establishment, ranging from a very simple folder with no features to folders which, for example, have a receptacle for a writing implement such as a ballpoint pen and a flap, tab or pocket into which, e.g., the bill may be inserted.

Suggestions have been made to provide such folders with additional features, as suggested in e.g. US-A-6050214 (a status indicator) or US-A-6076079 (a calculator).

The use of such folders is extremely widespread as it provides a satisfactory simple and convenient way of handling the manipulations required to carry out the final transaction, i.e. paying the bill.

It is very often the case that the final transaction of paying the bill is rendered more complex by circumstances outside the service establishment's control. In particular, it is not unusual for a bill to be split, sometimes among several parties, and not always into equal amounts. Particularly in the case of a bill which is actually being paid in several different ways, the additional complexity is often present that some parties wish to settle with cash and others by credit or charge card.

### GENERAL DESCRIPTION OF THE INVENTION

According to the present invention, in a presentation folder, the components of which are movable from a folded condition in which the interior of the folder is concealed to an open position in which the interior of the folder is disclosed, is improved by providing in the interior of the folder a plurality of individual pockets, each pocket shaped and sized to receive snugly a standard size credit or charge card and being physically associated with a re-markable surface area.

Preferably the interior of the folder also has a larger size pocket to enable the ends of one or several currency notes to be inserted therein.

A convenient arrangement is to have several, e.g. 6, credit card pockets, one side of the opened folder, conventionally the left hand side, and a pocket on the right hand side for currency notes or bills.

Preferably the re-markable area associated with each pocket is an oblong area of so-called “wipe-clean” plastics material. Preferably the folder contains a writing implement receptacle so that a writing implement may be provided for use when the payment transaction is being carried out and, more particularly, may be chosen to be a writing implement which is compatible with the application of a marking on to the re-markable surface area, and which can then be wiped off easily and quickly when desired.

The interior of the folder may also include a clip or pocket for the retention of the bill. For example, a clip may be mounted near the top of the right hand side of the folder when it is in the open position.

In the use of a folder of this type, the service establishment starts by producing the bill, placing it inside the folder and carrying the folder and bill to the intended payer. For a simple one-payer cash or card transaction, the folder may be used in traditional fashion, i.e. the payer simply places his or her card or cash into the folder, it is taken away and brought back with the bill and the change, or with the transaction validation slip for signature by the payer or validation via the Chip & PIN procedure. However, when there is more than one payer, the cards and/or cash may be inserted into the several respective pockets, and by writing on the re-markable section associated with each pocket, the payers can indicate to the service establishment e.g. how much of the bill is being paid by way of one or more credit or charge cards and how much in cash. The service establishment then processes the several payment transactions reflected in the folder, and if, for example, there are three credit or charge card transactions, then the authorisation slip which requires signature may be placed together with the credit or charge card which has just been “swiped” back in the relevant pocket. Once all of the individual proposed transactions have been processed in this way, the entire folder may be carried back e.g. to the table at which the diners were dining, and each of the authorisation slips then signed to authorise the transactions.

It will be readily appreciated that, working in this way, the possibility of confusion as between several credit cards on the one hand and several authorisation slips on the other can be materially reduced. It is highly desirable to reduce such instances of confusion because even if they are discovered at the time (and this is not always the case), they do not reflect well on the establishment in question. By using a presentation folder in accordance with the teachings of the present invention, a considerably larger number of transactions can be smoothly and efficiently processed in error-free fashion, giving a good impression to the customers and avoiding the downstream difficulties which would have arisen if an error had occurred. The benefits of its use also include a substantial element of time-saving; the less time is spent sorting out the bill, the more is available for attending to other customers.

Following the removal from the folder of the individual cards and duplicate authorisation slips by the customers, together with the removal of any change from cash tendered, and removal of the bill itself, the service establishment can then remove the service establishment copies of the authorisation slips and tender the folder ready for re-use by simply erasing the cash figures written on the re-markable areas.

As indicated above, the presentation folders in accordance with the present invention are of particular value in situations where a party of people wish to split payment among several payers. While, in some cases, calculation of such a split may be relatively straightforward and even within the mental arithmetic capabilities of those who have enjoyed a good meal, this is not always the case, particularly if splitting the bill into uneven portions is desired. For example, if there is a major difference in the cost of individual dishes consumed by different members of the party, it may be the wish of the party to reflect that in the differing contributions made by several members.

In order to facilitate such activity, it is accordingly useful to incorporate, within the presentation folder, a simple low profile four-function calculator. Such calculators are produced in a very wide variety of shapes, sizes and styles. Any appropriate calculator unit may be incorporated into the presentation folder, most preferably one of those which closely approximates in size and configuration to a “credit card”.

The folder itself may be manufactured from a wide variety of materials appropriate for the purpose. Very often it will be made from a combination of a fairly rigid material, to provide the basic folder shape and stiffness, e.g. card or a thin aluminium sheet overlaid with some appropriate flexible covering material from which the pockets may also be constructed. Examples of suitable such materials are leather, plastics sheet materials and fabric. For run-of-the-mill general use, plastics, so-called “vinyl”, covered folders are widely produced for an enormous variety of purposes and the presentation folders of the present invention may be made by analogous methods and using the same materials. For the wipe clean areas which may be marked with the sum of money to be taken from cash or applied to a credit or a charge card, any of a range of wipe-clean plastics materials may be incorporated into the presentation folder in simple fashion, e.g. by adhesion, welding or sewing.

Both interior and exterior of the folder may bear appropriate markings, e.g. to indicate how the folder is used, or, for example, to reflect the identity of the service establishment, e.g. with a name or logotype. Other conventional methods of ornamenting or enhancing folders, for example metallic, coloured or blind embossing may also be employed.

### Description of Preferred Embodiment

A preferred embodiment of the invention is illustrated by way of example, in the accompanying drawings:

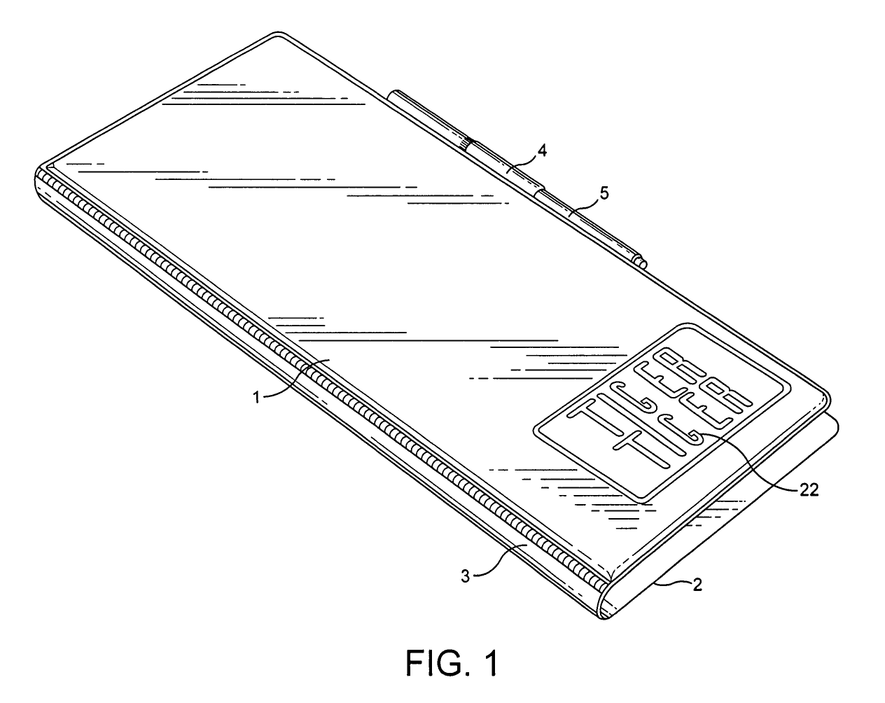

FIG. 1 is a perspective view a folder in accordance with the invention in folded condition, and

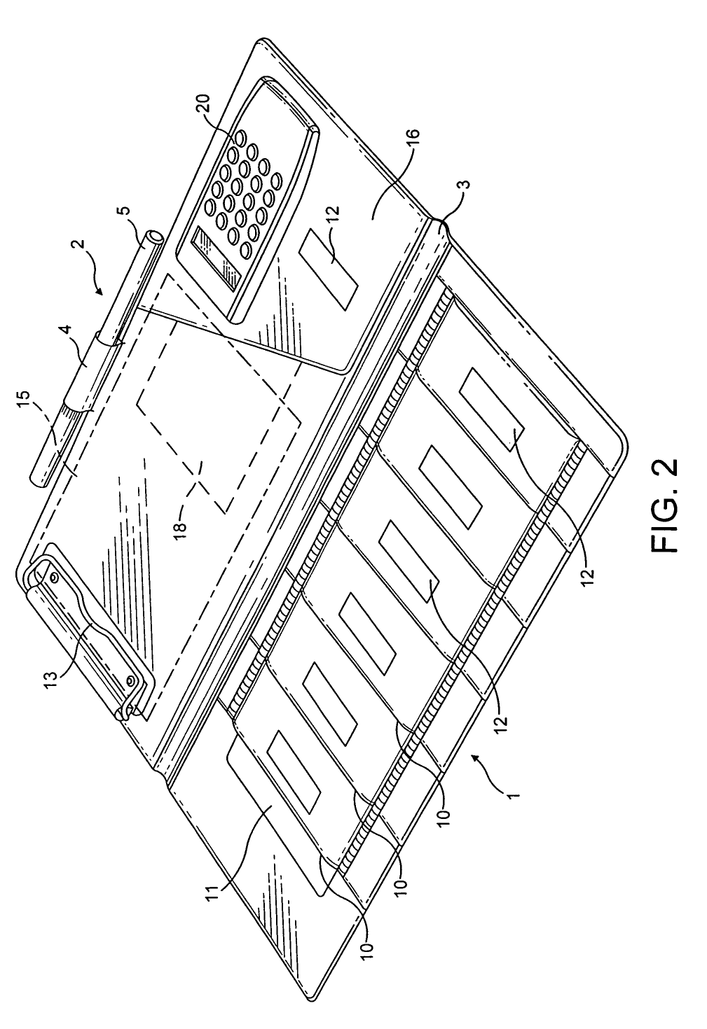

FIG. 2 is a perspective view of the folder of FIG. 1 in opened out condition.

Referring to these drawings, as can be seen when the folder is in folded condition, it consists basically of a front and back section 1 and 2 respectively which may be connected to one another about hinge line 3. Set on one edge of the back section 2 is an elongate sleeve 4, e.g. for the reception of a marker pen 5.

When the sections 1 and 2 are folded apart, hinging round line 3, the interior of the presentation folder is exposed. As can be seen, on the left-hand side, the interior of the folder has six pockets, each of which is defined by an open slot 10. The bottom of the pocket is positioned and dimensioned such that a credit card or charge card may be inserted into the slot 10 and pushed down until it comes to rest with a small proportion of the card, e.g. between 5 and 8 mm wide, protruding from the pocket, as shown at 11. Associated with each of the slots 10 is an area of wipe-clean material 12. This may be chosen to be compatible with the marker pen 5 and may, if desired, be pre-printed with a $ sign to indicate to the user what the small usually white wipe-clean area is actually there for. The edge of slot 10 may be rigidified or made of thicker material to facilitate slotting a credit or charge card into it. The pocket may be transparent and any overlying material transparent if desired to enable the type of card to be more easily identified, i.e. they do not then have to be removed from the pocket to identify them or (if swiping is not used) to enter the card number by hand.

On the right-hand portion 2, near the top of the inside of the folder is mounted a lightly sprung clip 13 into which the bill may be inserted, the outline of the bill being depicted in dash-dot lines denoted 15.

On the side of the portion 2, towards the lower edge of the folder as shown in the accompanying drawing, there is located a covering layer 16 having a further remarkable section 12 on the outside thereof. Section 16 forms a rather large and fairly deep pocket into which a wad of paper currency, indicated by dashed lines and denoted 18 in the drawing, may be inserted. It may also, when the folder is presented, contain promotional material for the establishment, e.g. a flyer for a forthcoming special event or a voucher redeemable against the next transaction.

In order to allow the appropriate figures which are to be written by the customers on sections 12 to be appropriately and accurately calculated, a four-function calculator 20 is built into the lower portion of section 2. It may be secured in place by adhesion or other convenient means. The calculator 20 may be battery operated, or (and this is preferable because it reduces maintenance) have a “solar panel” which provides when illuminated sufficient power to enable the calculator to be used, provided the lighting in the establishment is not too low.

The interior of the presentation folder may contain printed on it appropriate markings to encourage its use, or even a few lines of simple instruction. The exterior of the folder may bear a suitable service establishment identifier, for example an embossed logo indicated generally at 22.

1. In a presentation folder, comprising a pair of components movable from a folded condition in which the interior of the folder is concealed to an open position in which the interior of the folder is disclosed, the improvement comprising providing in the interior of the folder a plurality of individual pockets shaped and sized to receive snugly a standard size credit or charge card and each pocket being physically associated with a re-markable surface area.

2. The presentation folder of claim 1 wherein the re-markable area associated with each pocket is an oblong area of so-called “wipe-clean” plastics material.

3. The presentation folder of claim 1 and containing a writing implement receptacle.

4. The presentation folder of claim 3 and including, in the receptacle, a writing implement which is compatible with the application of a marking on to the re-markable surface area, which marking can be wiped off easily and quickly when desired.

5. The presentation folder of claims 1 and further including in the interior of the folder a clip or pocket for the retention of a paper bill.

6. The presentation folder of claim 1 and including a calculator.

7. The presentation folder of claim 1 wherein the components are constructed and made from a combination of a fairly rigid material to provide a basic folder shape and stiffness, and a flexible covering material, overlaid on the rigid material.
